(19) United States
(12) Patent Application Publication
(10) Pub. No.: US 2024/0257352 A1
(43) Pub. Date: Aug. 1, 2024

(54) SEGMENTING METHOD FOR EXTRACTING A ROAD NETWORK FOR USE IN VEHICLE ROUTING, METHOD OF TRAINING THE MAP SEGMENTER, AND METHOD OF CONTROLLING A VEHICLE

(71) Applicant: GRABTAXI HOLDINGS PTE. LTD., Singapore (SG)

(72) Inventors: Wenmiao HU, Singapore (SG); Yifang YIN, Singapore (SG); An TRAN, Singapore (SG); Hannes Martin KRUPPA, Singapore (SG); Roger ZIMMERMANN, Singapore (SG)

(21) Appl. No.: 18/561,049

(22) PCT Filed: May 25, 2022
(86) PCT No.: PCT/SG2022/050350

§ 371 Date: Nov. 15, 2023

(30) Foreign Application Priority Data
Jun. 30, 2021 (SG) 10202107190U

(51) Int. Cl. G06T 7/10; G01C 21/00; G06T 11/60; G06V 10/764; G06V 20/10; G06V 20/56

(52) U.S. Cl. CPC G06T 7/10; G01C 21/3804; G06T 11/60; G06V 10/764; G06V 20/182; G06V 20/56; G06T 2207/20081

(57) ABSTRACT

Computer-implemented training method of training a map segmenter including a deep neural network, including: providing a training dataset including training image data including training pairs of map images of a geographical area acquired by one or more image acquisition apparatuses and corresponding segmentation masks, wherein the training image data may be stored a computer memory; generating synthetic map images by a computer-implemented generation method including creating synthetic map images by applying a generative adversarial network onto segmentation masks, wherein the segmentation masks may include the corresponding segmentation masks and additional segmentation masks; storing the synthetic map images and the corresponding additional segmentation masks as additional training data pairs in the training dataset in the computer memory; and training the map segmenter with the training dataset. Computer-implemented segmenting method for extracting a road network for use in vehicle routing with the trained segmenter, and a computer program product are also disclosed.

### TECHNICAL FIELD

An aspect of the disclosure relates to a computer-implemented training method of training a map segmenter. Another aspect of the disclosure relates to a computer-implemented segmenting method for extracting a road network for use in vehicle routing.

### BACKGROUND

The service of ride-hailing providers significantly relies on the quality of a digital map. Incomplete satellite image such as a missing road or even a missing road attribute can lead to misleading routing decisions or inaccurate prediction of a driver's arrival time. However, the updating of both commercial and free maps still heavily relies on the manual annotations from human. The high cost results in maps with low completeness and inaccurate outdated data.

Therefore, current methods of generating digital maps from satellite image have drawbacks and it is desired to provide for an improved method of generating digital maps.

### SUMMARY

An aspect of the disclosure relates to a computer-implemented training method of training a map segmenter including a deep neural network, including:
providing a training dataset including training image data including training pairs of map images of a geographical area acquired by one or more image acquisition apparatuses and corresponding road segmentation masks (also named herein as corresponding segmentation masks), wherein the training image data may be stored a computer memory;
generating synthetic map images by a computer-implemented generation method including creating synthetic map images by applying a generative adversarial network onto segmentation masks, wherein the road segmentation masks (also named herein as segmentation masks) may include the corresponding segmentation masks and additional road segmentation masks (also named herein as additional segmentation masks);
storing the synthetic map images and the corresponding additional segmentation masks as additional training data pairs in the training dataset in the computer memory; and
training the map segmenter with the training dataset.

An aspect of the disclosure relates to a computer program product including program instructions, which when executed by one or more processors, cause the one or more processors to perform the training method.

An aspect of the disclosure relates to a computer-implemented segmenting method for extracting a road network for use in vehicle routing, the segmenting method including:
providing a trained segmenter, including the deep neural network, trained by using the training dataset of the training method;
providing processing image data including overhead map images acquired by one or more image acquisition devices;
segmenting, by the trained segmenter, each of the overhead map images thereby determining attributes to different portions of the image;
storing the segmented images and the attributes as a road network in a database memory for access by vehicle routing services. The road network may be transformed into or used to produce a road map, e.g., a vectorized road map.

The method for extracting a road network may further be used for controlling a vehicle, and may further include, by a computing system, receiving, by a communication interface, a route request from a vehicle. The method may further include, by the computing system, applying a route solver on the route request and the road map, thereby providing a viable route for the vehicle. The method may further include, by the computing system, sending route data of the viable route to the vehicle. The method may further include, by the computing system, navigating (e.g., controlling) the vehicle along the route.

An aspect of the disclosure relates to a computer program product including program instructions, which when executed by one or more processors, cause the one or more processors to perform the segmenting method.

### BRIEF DESCRIPTION OF THE DRAWINGS

The invention will be better understood with reference to the detailed description when considered in conjunction with the non-limiting examples and the accompanying drawings, in which:

FIG. 1 shows an exemplary flowchart in accordance with various embodiments, which will be used as illustration in below description;

FIG. 2 shows a schematic diagram illustrating elements of the disclosure, an image acquisition apparatuses SAT1;

FIG. 3A illustrates a schematic structure of a conditional-single natural image generative adversarial network set (cSINGAN);

FIG. 3B illustrates a schematic structure a Multi-Categorical-cSinGAN;

FIG. 3C shows a schematic illustration of an exemplary generator structure;

FIG. 4 shows a GAN structure as used by cSinGAN and as used by Multi-Categorical-cSinGAN;

FIG. 5 illustrates a computer-implemented generation method 200;

FIG. 6 illustrates an exemplary flow of the disclosure, in which a same generative adversarial network GAN may be used for creating synthetic map images 42 by augmenting the map images 22, and for creating a synthetic image of the synthetic images 42;

FIG. 7 shows a schematic of the calculation of different types of scores;

FIG. 8 shows a flowchart of a computer-implemented segmenting method 300 for extracting a road network for use in vehicle routing;

FIG. 9 shows a flowchart of further optional method steps of method 300; and

FIG. 10 shows a schematic of a user's mobile device 70, and a vehicle 80 which may communicate via a computing system 60.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the training methods are analogously valid for the other training methods or segmenting methods. Similarly, embodiments described in the context of a segmenting methods are analogously valid for a training method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

As used herein, and in accordance with various embodiments, the term “map image” (and its plural) is used herein to indicate an overhead image (or overhead images). For example, a map image may be an overhead image of a (existing) geographical area of earth, such as a satellite image of the geographical area. Conversely, a synthetic map image may be an overhead image that is either of a modified map image (of a geographical area) or a synthetic image which is not related to the geographical area.

As used herein, and in accordance with various embodiments, the synthetic map image may mean an augmented image generated from the generator by using existing road masks from the geographical area. Alternatively, the synthetic map image may be a synthetic image (i.e., a completely new image) also named herein as created image (or artificially creative new image). In the present disclosure, a synthetic map image is a created image when generated based on an external segmentation mask (not corresponding to the geographical area), and the synthetic image is an augmented image when generated based on a corresponding segmentation masks corresponding to the map images. The external segmentation mask is also named herein as additional segmentation mask.

As used herein, and in accordance with various embodiments, a segmentation mask (e.g., an additional segmentation mask, a corresponding segmentation mask) is a digital representation indicating, on its related map image or synthetic map image, whether a pixel corresponds to road or not. For example, the representation may be binary, and a zero may indicate road and a one may indicate no road (or the vice-versa). For example, a training part may include a map image of dimension 1024 pixels×1024 pixels and a binary corresponding segmentation mask of 1024 pixels×1024 pixels. In some embodiments, each pixel of the mask may be one bit, and during representation more bits may be used for each pixel.

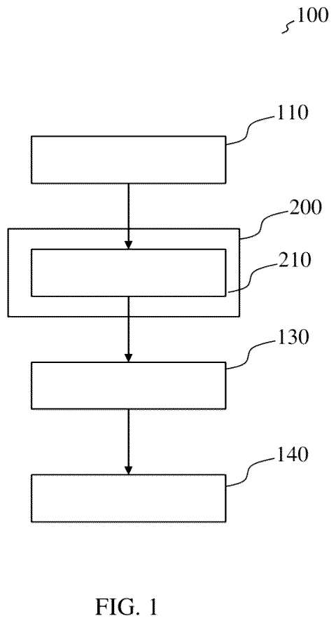

FIG. 1 shows an exemplary flowchart in accordance with various embodiments, which will be used as illustration in below description, that, however, is not limited to the drawings. A computer-implemented training method 100 of training a map segmenter 10 including a deep neural network includes providing 110 a training dataset TDS1. The training dataset TDS1 includes training image data including training pairs TDP1 of map images 22 of a geographical area GA1 and corresponding segmentation masks 32. The image data is acquired by one or more image acquisition apparatuses SAT1, for example, satellites. The training image data may be stored in a computer memory CM1.

The computer-implemented training method 100 includes generating synthetic map images 42 by a computer-implemented generation method 200. The computer-implemented generation method 200 includes creating 210 synthetic map images 42 by applying a generative adversarial network GAN onto segmentation masks 30. The segmentation masks 30 may include the corresponding segmentation masks 32 and additional segmentation masks 34. For example, the additional segmentation masks 34 may be provided by external sources, may correspond to another geographical area than the geographic area GA1 of the image data, may be generated (i.e., synthetic data), or a combination thereof.

According to various embodiments, segmentation masks 30 may include the segmentation masks 32 and additional segmentation masks 34. A segmentation mask may be a binary mask to indicate the pixels corresponding to roads. In examples, the map images' corresponding segmentation masks 32 may be created by human annotation, e.g., as a ground truth to the map images 22.

The computer-implemented training method 100 includes storing 130 the synthetic map images 42 and the corresponding masks 30 as additional training data pairs TDP2 in the training dataset TDS1 in the computer memory CM1. The storing 130 may be part of the computer-implemented generation method 200. The computer-implemented training method 100 includes training 140 the map segmenter 10 with the training dataset TDS1.

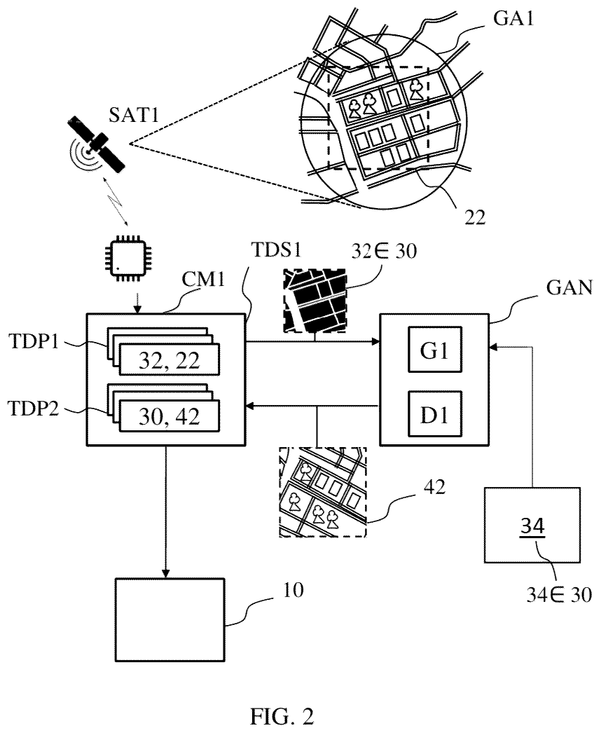

FIG. 2 shows a schematic diagram illustrating elements of the disclosure, an image acquisition apparatuses SAT1 (e.g., a satellite) may acquire images, such as map image 22, from the geographical area GA1. Map image 22 may include roads, and background which may include blocks, buildings, trees, etc. Map image 22 may be stored and transmitted in the form of image data. Map images 22 may be send, e.g., provided, to a computer system, e.g., to be stored in computer memory CM1. Computer memory CM1 may store the training data as training pairs TDP1 of map images 22 and their corresponding segmentation masks 32, denoted for example as (32, 22). The segmentation masks 32 may be created for the map images according to any suitable method. The generative adversarial network GAN includes a generator model and a discriminator model configured to contest which each other, and which are trained with training data pairs TDP1 of map images 22 of a geographical area GA1 and corresponding segmentation masks 32, which are non-synthetic data. The (trained) generative adversarial network GAN is applied onto each of the segmentation masks 32 and/or onto each of the additional segmentation masks 34. The trained generative adversarial network GAN (herein, the generator is used without the discriminator) generates synthetic map images 42, one or more for each segmentation masks 30. For example, synthetic map images 42 may be generated for each of the segmentation masks 32, which may be stored in memory as training pairs, e.g., (32, 42). For example, synthetic map images 42 may be generated for each of the segmentation masks 34, which may be stored in memory as training pairs, e.g., (34, 42). Storage may be in computer memory CM1 and thus may be made available for training the map segmenter 10, the storage format may be denoted for example as (30, 42) which may include (32, 42) pairs and (34, 42) pairs, wherein 34, 32 ∈ 30.

According to some embodiments, the additional segmentation masks 34 may be provided by a segmentation mask database and wherein the additional segmentation masks 34 may be different from the corresponding segmentation masks 32 corresponding to the map images 22. Alternatively, or in addition, according to some embodiments, the additional segmentation masks 34 may be provided by a segmentation mask generator configured to generate a representation of a road network and transform the representation into a mask.

The one or more generated synthetic map images 42, generated for each mask of the segmentation masks 30 may form a batch. For example, one map image 22 and the corresponding segmentation mask 32 may form a real image batch. For example, all synthetic map images 42 generated for a segmentation mask 32 may form a synthetic image batch. For example, all synthetic map images 42 generated for a segmentation mask 34 may form a synthetic image batch. The synthetic map images 42 and the corresponding additional segmentation masks 34 may be stored as additional training data pairs TDP2 in the training dataset TDS1 in the computer memory CM1 and thus may be made available for training the map segmenter 10, the storage format may be denoted for example as (30, 42) which may include (32, 42) pairs and (34, 42) pairs, wherein 34, 32 ∈ 30. Batches may be stored in the form as training pairs. Batches may be used latter for testing the quality of the images as will be detailed further below.

According to various embodiments, the generative adversarial network GAN may be trained by training: a generator model G1 with a segmentation mask of the segmentation masks 32 (corresponding to map image 22); and a discriminator model D1 configured to discriminate between the synthetic map image(s) 42 generated by the generator model G1 and a map image 22 corresponding to the segmentation mask. In other words, the discriminator model D1 determined whether a given synthetic map image 42 is real or synthetic. D1 updates based on whether D1 determined it correctly, and G1 updates based on whether it was able to fool D1 (meaning that a synthetic map image 42 was determined as real by D1). Generator model and discriminator model are trained together. At inference time, the discriminator D1 is not used, therefore the trained generative adversarial network GAN may be free of discriminator D1, e.g. for further use.

According to various embodiments, creating 210 synthetic map images 42 may include augmenting the map images 22 by applying the generative adversarial network GAN on the corresponding segmentation masks 32 thereby producing augmented map images 42; and the training method 100 may include storing the augmented map images 42 with their corresponding segmentation masks 32 in the training dataset TDS1 in the computer memory CM1. E.g., the generative adversarial network GAN may be trained to add background, create additional road network structures as given by an additional segmentation mask 34, or a combination thereof.

According to various embodiments, creating 210 synthetic map images 42 may include creating a synthetic image (i.e., a completely new image) by applying the generative adversarial network GAN onto an additional segmentation mask included in the additional segmentation masks 34, creating may be without any other input corresponding to the geographical area G1, e.g., without using the map images 22 and/or their corresponding segmentation masks 32. The additional segmentation mask may be non-corresponding to the map images and to the geographic area, for example the, the additional segmentation masks 34 may be provided by external sources, may correspond to another geographical area than the geographic area GA1 of the image data, may be generated (i.e., synthetic data), or a combination thereof. Creating 210 synthetic map images 42 may include creating and adding map features, unseen in the map images, in the map images, thereby producing new, synthetic map images 42 (the original map images may be kept stored unchanged).

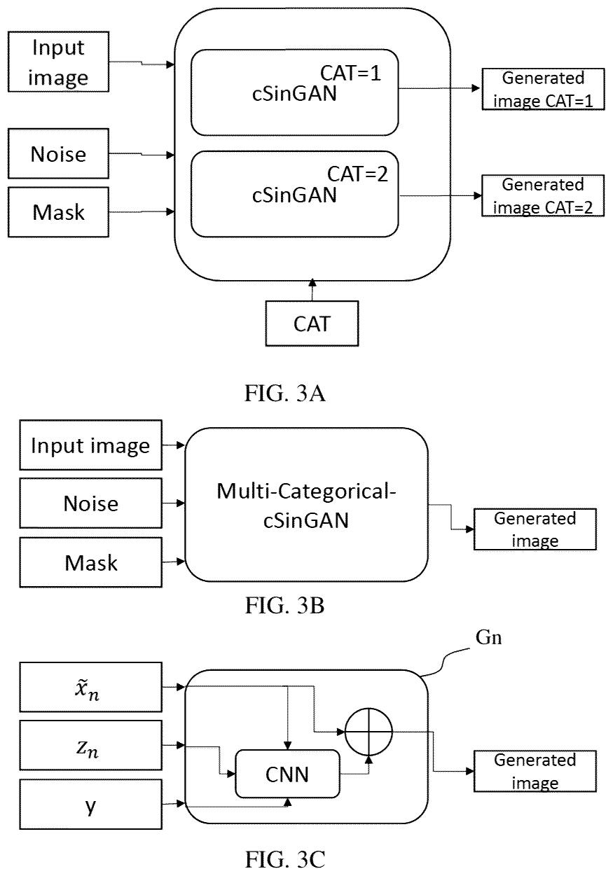

According to various embodiments, the generative adversarial network GAN may be a cSinGAN set which may include two or more cSinGANs CAT=1, CAT=2, each trained for a category of multiple categories. 2 generators CAT=1, CAT=2, are shown for illustration purposes in FIG. 3A. Each generator CAT=1, CAT=2 comprises, as in a typical generative adversarial network, a multi-scale generator set, also named herein as multi-scale subgenerator set. The training method 100, further may include, for each generator GEN1, GEN2, inputting a noise tensor into the cSinGAN. cSinGAN is improved on single natural image generative adversarial network (SinGAN). The comparative SinGAN only learns from one image and allows the user to generate different variations of this image. By using multiple Generator-Discriminator pairs, SinGAN generates images from low scales to high scales. In the training phase, it optimizes on both the reconstruction task (when an anchor noise is used) and the generation task (when other noises are used in the generator). As the reconstruction loss is only used in the reconstruction task, the generator has more flexibility to generate diversified images compare to pix2pix for example. Although SINGAN can generate diversified synthetic data for high-resolution images, it is not ideal for generating synthetic image-ground truth pairs, as the generator does not take a reference image to guide the scene structure of the generated image.

Conditional-SINGAN (cSINGAN) is enhanced based on SINGAN to generate multiple images with conditional inputs, while only learning from one image ground truth pair (x, y). According to various embodiments, to enforce the generated image follows a given road segmentation mask, the resized mask may be added as one of the inputs, in other words, the road segmentation mask may be resized, and then added as one of the inputs in addition to the (non-resized) road segmentation mask. To avoid overfitting on the only training pair, diversity-sensitive loss (L_{ds}(G, y, z)) may be added, the diversity loss may be determined between the reconstructed image (reconstructed based on z_{rec}) and the generated based on z_{rand} generated by each subgenerator, while both the reconstructed and generated image are based on segmentation mask. One example of an equation of diversity sensitive loss is:

$${L}_{ds} ( G , y , z ) = clip ( \frac{{L}_{2} ( g ( y , {z}_{rec} ) , G ( y , {z}_{rand} )}{‖ {r}_{rec} - {z}_{rand} ‖} , {λ}_{ds} ) \qquad EQ ( 1 )$$

wherein L₂(G(y, z_{rec}), G(y, z_{rand})) is the L₂ loss between the generated image and the reconstructed image, the reconstructed image G (y, z_{rec}) is generated based on segmentation mask y and noise z_{rec}, the generated image G(y, z_{rand})) is generated based on segmentation mask y and noise z_{rand}, and the clip function limits the values within the range of [0, λ_{ds}], wherein λ_{ds} is the regularization rate.

The diversity-sensitive loss forces the generator to give different synthetic map images 42 if different input noises are used. It is desired to have the synthetic map image, which is a random generated image, to be different from the reconstructed image. Hence, when doing the inference, the generator is not giving identical images regardless of the noise.

A comparative generator is known as pix2pix. Pix2pix is a task agnostic GAN model to generate images referencing another given image. It enables the image translation between one type and another by learning two sets of images one from each type. To guide the generated image to look similar to the real image, L1 loss between the real images and the generated images is added on top of the GAN loss. Although it improves the quality of the synthetic image, the model only generates similar output for the same reference image. Moreover, results have shown that pix2pix has degraded performance on high-resolution image generation.

According to various embodiments, the generative adversarial network GAN may include a conditional-single natural image generative adversarial network cSinGAN (a set thereof) or a derivate thereof (or a set of the derivative). A cSinGAN set is schematically illustrated in FIG. 3A. The cSinGAN set includes two or more trained cSinGAN (2 generators CAT=1. CAT=2, are shown for illustration purposes), while the discriminators are used for training and may be discarded for infering. Each of the generators CAT=1, CAT=2, corresponds to one category, and is trained with images from a category. According to various embodiments, categories may be, e.g., selected from: brownish city, whitish city, red field, forest, waterbody, green field, desert.

According to various embodiments, the cSinGAN for different categories may have identical structure, architecture, and identical training methods may be used. However, since the cSinGAN of each category is trained for a different image, the weights of the generators and discriminators are different, for example, 2 cSinGAN Gw (CAT=1) and Gf (CAT=2) will be different and 2 discriminators Df and Dw will different. For example, cSinGAN forest trained on forest (both Gf and Df) will be different from cSinGAN waterbody trained on waterbody (both Gw and Dw). Each cSinGAN has one multi-scale subgenerator set (e.g., for Gw={Gw1, Gw2 . . . , GwN}), and one multi-scale subdiscriminator set (e.g., for Dw={Dw1, Dw2 . . . , DwN}). For example, the cSinGAN set of CAT=1 and CAT=2 may include (Gw={Gw1, Gw2 . . . , GwN}, Gf={Gf1, Gf2 . . . , GfN}), and one multi-scale subdiscriminator set (Dw={Dw1, Dw2 . . . , DwN}, Df={Df1, Df2 . . . , DfN}). Then after training, the discriminators (in the example, Df, and Dw) may be discarded and Gf and Gw are kept. Gf and Gw are not physically combined. It is possible to generate images from Gf for the forest images, and to generate images from Gw separately. The generated images from each generator is combined into the result.

The cSinGAN receives as input a mask tensor and a noise tensor. The cSinGAN comprises a plurality of neural network layers grouped into residual units (for example, residual units Gw1, Gw2 . . . , GwN, Gf1, Gf2 . . . , GfN). Each residual unit may generate an image of a different scale, for example a first unit may generate a [10×10] pixels image, a second unit may generate a [20×20] pixels image, and a further unit may generate a [1024×1024] pixels image. Each unit may include a head, a sequence of convolution blocks, and a tail.

The head (illustrated below as Model. Head by way of example) may include a convolution layer, which may be followed by a normalization layer, which may be further followed by an activation function (e.g. ReLu, or LeakyReLu). The activation function may be in the form of an activation layer. The sequence of convolution blocks (illustrated below as Model.Convolution Blocks by way of example) may include a sequence of N blocks (wherein N is an integer greater than 2), each block of the sequence may include a convolution layer, which may be followed by a normalization layer, which may be further followed by an activation function (e.g. ReLu, or LeakyReLu). The activation function may be in the form of an activation layer. The tail (illustrated below as Model.Tail by way of example) may include a convolution layer and may be followed by an activation function, e.g. TanH (hyperbolic tangent). The activation function may be in the form of an activation layer.

In one example, a residual unit (Gₙ) is defined as:

```
Model.Head:
  2D convolution layer
  Layer Normalization
  Activation Layer Leaky ReLU
Model.Convolution Blocks has N blocks, each outputting a different
normalization size into the next:
  Convolution Block:
    2D convolution layer
    Layer Normalization (size)
    Activation Layer Leaky ReLU
Model.Tail:
  2D convolution layer
  Activation Layer TanH
```

Each residual unit may receive as input (x) the previous image (for any unit other than the first unit), noise, and segmentation mask, e.g., as a tensor. The output from each residual unit may be obtained, e.g., as:

$$Output = Model . Tail ( Model . Convolution Block ( Model . Head ( x ) ) ) + previous image$$

According to various embodiments, the generative adversarial network GAN may be a Multi-Categorical-conditional-single natural image generative adversarial network or a derivate thereof. A schematic illustration of an exemplary generator structure is shown in FIG. 3C of cSinGAN and Multi-Categorical-cSinGAN.

According to various embodiments, the generative adversarial network GAN may be a Multi-Categorical-cSinGAN or a derivate thereof. A Multi-Categorical-cSinGAN is schematically illustrated in FIG. 3B. The Multi-Categorical-cSinGAN includes a generator and a discriminator for training, for example one generator and one discriminator. The discriminator is not required for inference, in other words, the discriminator is not required when using the trained Multi-Categorical-cSinGAN.

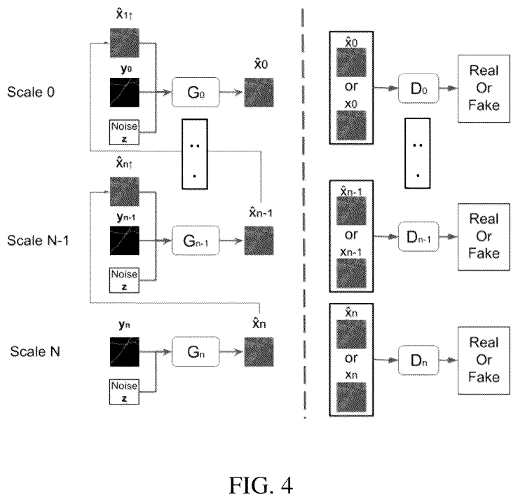

FIG. 4 shows generator structures as used during training, the same structure without the discriminators may be used during inferring. FIG. 4 shows a basic GAN structure as used by cSinGAN and as used by Multi-Categorical-cSinGAN. It can be seen that the residual units (Gₙ=G0 . . . GN) have different sizes. The DO to DN may be used for training and need not be used in the inference for image generation. The generated output from each residual unit is combined together. The Multi-Categorical-cSinGAN receives as input a mask tensor and a noise tensor which are input in the first residual unit (G0), the noise tensor is selected according to the desired category CAT. The generated image corresponds to the category of the noise tensor. In both the cSinGAN and the Multi-Categorical-cSinGAN, scale is indicated by Scale 0 . . . N, noise is indicated by z, the box “ . . . ” indicates that there may be more residual units than shown. \hat{x}_{n(n=0..N)} represents the generated image which is compared by the discriminator Dn to the input image x_{n(n=0..N)} which then decides whether the generated image is real or fake.

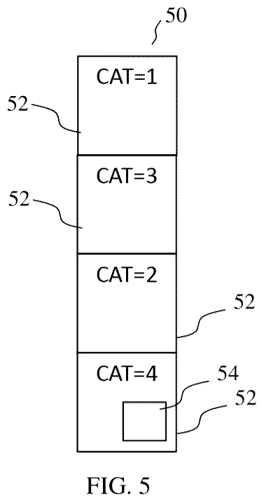

According to various embodiments, the computer-implemented generation method 200 may further include selecting a noise section 54 from a region 52 of a noise space 50 (as illustrated in FIG. 5), the noise region 52 corresponding to a given category of the categories (e.g., CAT=1, CAT=2, CAT-3, CAT-4), wherein the noise section 54 may be randomly selected within the noise region 52. The computer-implemented generation method 200 may further include inputting the noise section 54 as noise tensor into the first residual unit (GN) of of the Multi-Categorical-cSinGAN. Since the Multi-Categorical-cSinGAN has the category defined by the noise space, it is therefore much faster to train. According to various embodiments, categories may be, e.g., selected from: brownish city, whitish city, red field, forest, waterbody, green field, desert. The generator learns from multiple image training pairs instead of only one for cSinGAN. During training, the noise is strictly paired with the categorized map image. The generator, once trained, remembers to which category the noise belongs, since for training and inference the noise section is sampled from the same region 52. “Remembering” in this context, means that the generate synthetic map image will have the appearance from the respective category. A Multi-Categorical-cSinGAN may be used to generate multi-categorical synthetic map images by learning only one map image in each category.

Multi-Categorical-cSinGAN is an enhanced version of cSinGAN. It is designed to generate images with multi-category appearances. Instead of training multiple cSinGAN generators to achieve the goal, Multi-Categorical-cSinGAN breaks-down the latent noise space into multiple regions to allow the generator to learn different appearances in its designated noise region. For each category, one training map image—segmentation mask pair is sufficient. As the result, the generator can give different appearances for the same road mask (segmentation mask).

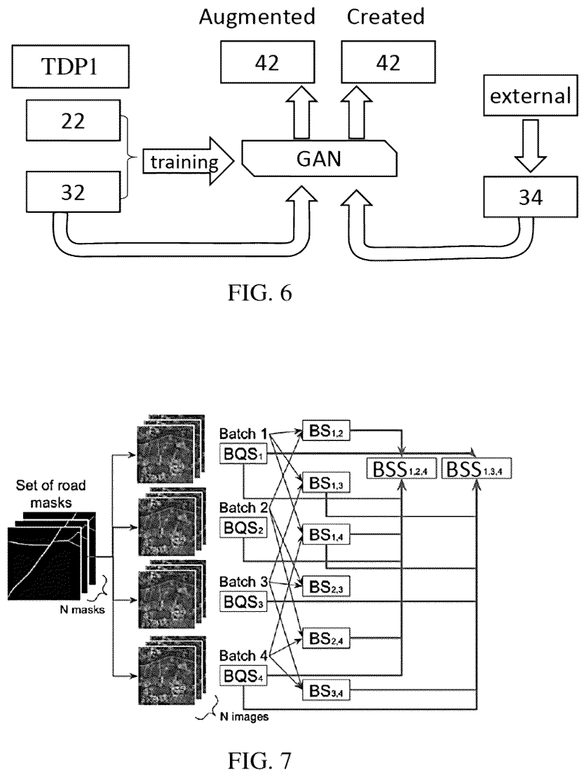

Thus, as illustrated in the schematic of FIG. 6, a same generative adversarial network GAN may be used for creating augmented images by augmenting the map images 22, and for creating a synthetic image (i.e., a completely new image). Both, the augmented images and the synthetic images are referred herein as synthetic map images. The generative adversarial network GAN may be trained with training data pairs TDP1 of map images 22 of a geographical area GA1 and corresponding segmentation masks 32, which are non-synthetic data. For augmenting images, the input to the GAN may be the segmentation masks 32, and for creating new images (synthetic images), the input may be an external segmentation mask 34 (refer above to explanations on noise and category input). According to various embodiments, a limited real dataset can be extended at both the appearance and scene structure level. For road segmentation, it means to augment existing samples with different types of background environments and to cover additional road network structures. The self-augmentation strategy is used to generate multiple different images for the same road binary mask. It does not require additional data on top of the existing dataset. The GAN is trained with one (or a multiple) map image—segmentation mask pair(s) (the segmentation mask being the ground truth) or the full existing dataset to learn the one type (or multiple types) of background environments. Training of the GAN is performed with the generators and the discriminators. The augmented images are generated from the generator by using existing road masks. With the same generator, the second strategy scene-creation is used to enhance the coverage of road network structures in the dataset. According to various embodiments, new (synthetic) training pairs are generated from unseen road masks (segmentation masks), which are road masks of roads not seen in the images from geographical area GA1, e.g., not existing in reality or from another geographical area different from the geographical area GA1. These unseen road masks can be synthesized from other resources or created at negligible cost compared to acquiring and annotating additional satellite images. In both cases, a same generative adversarial network GAN may be used to generate synthetic satellite images from road masks.

According to various embodiments the training dataset may include one or more batches, each batch thereof including a segmentation mask and a plurality of synthetic map images generated from the segmentation mask. E.g., for same categories or for different categories. The training method may further include calculating a batch quality score BQS for each batch as shown schematically in FIG. 7 for illustration purposes. The shown set of road masks is a set of segmentation masks 30, for example a set of segmentation masks 32, of additional segmentation masks 34, or a mixture thereof. The shown N images are shown in 4 batches, each batch illustrated by a set of 3 synthetic map images 42. According to various embodiments, the training method 100, may further include comparing the batch quality scores of different batches and selecting a batch having a highest batch quality score BQS among one or more batches, e.g., if only one batch is required. As the generated synthetic map images are consumed by the segmentation model, the proposed batch image quality score may evaluate one or more of: realness of the synthetic map image, appearance distance (AD), and whether it contains the information of the road masks for the segmentation model, content information distance (CID).

According to various embodiments, the training method 100, may further include comparing the batch quality scores of different batches and calculating a batch similarity BS, in the illustrated example for 4 batches they are BS_{1.2}, BS_{1.3}, BS_{1.4}, BS_{2.3}, BS_{2.4}, BS_{3.4}. The training method 100 may further include calculating a batch selection score BSS based on the batch similarity BS and the batch quality score BQS. The BQS, for the illustrated example are BQS₁, BQS₂, BQS₃, BQS₄. The BSS, for the illustrated example are BSS_{1.2.4}, and BSS_{1.3.4}.

The batch quality score BQS may be calculated based on the appearance distance and the content information distance. The batch similarity may be calculated based on the pairwise structural similarity of two synthetic map images generated with the same segmentation mask.

According to various embodiments structural similarity may be multiscale structural similarity index measure (MS-SSIM). Appearance Distance aims to find whether an image batch has a similar texture and appearance as the reference image set. To assess AD, an autoencoder may be trained using only the reference image set. By comparing the MS-SSIM and L2 reconstruction loss of the test and reference image sets through the autoencoder, AD may be calculated by:

$$AD = \sqrt{\frac{{( MS - SSIM ( {X}_{g} ) - MS - SSIM ( {X}_{r} ) )}^{2} + {( L 2 ( {X}_{g} ) - L 2 ( {X}_{r} ) )}^{2}}{2}} \qquad EQ ( 2 )$$

wherein MS-SSIM is the multiscale structural similarity index measure, L2 is the reconstruction loss, X_{g} is the generated image, and Xᵣ is the overhead map image.

Content Information Distance (CID) may be based on kernel inception distance with kernel k(x,y)=(f(x)·T f(y)/d+1)\hat{ }3 and further, may be based by changing the inception model to the pre-trained segmentation model on the real image set. The bottleneck feature map f may be used to evaluate the maximum mean discrepancy (MMD). between the real (X) and generated (Y) dataset. MMD is a measurement which may be used to compare the difference between two distributions, for example using the outer structure involving n m and k (x,x) k(x,y) and k(y.y). The evaluation may be done with subsets, such as subset size n=300 and m=200 subsets. The contend information distance may be calculated by:

$$CID ( X , Y ) = \frac{1}{m} {\sum }^{m} ( \frac{{\sum }_{i \neq j}^{n} ( k ( {x}_{i} , {x}_{j} ) + k ( {y}_{i} , {y}_{j} ) )}{n ( n - 1 )} - \frac{{\sum }^{n} k ( {x}_{i} , {y}_{j} )}{0.5 {n}^{2}} ) \qquad EQ ( 3 )$$

wherein X are the overhead map images, and Y are the synthetic images, n is the subset size, m is the number of subsets, f(x,y) is the kernel function, and indices i and j refer to the images.

The batch quality score BQS for a batch batchᵢ may then be calculated by:

$$BQS ( {batch}_{i} ) = \frac{- {log}_{10} AD ( {batch}_{i} )}{1 - {log}_{10} AD ( {batch}_{i} )} \times \frac{{e}^{- 1}}{CID ( {batch}_{i} ) + {e}^{- 1}} \qquad EQ ( 4 )$$

If more than one batch is required:

$$BS ( {batch}_{i} , {batch}_{j} ) = \frac{1}{m} {\sum }_{n ∈ m} MS - SSIM ( {x}_{i n} , {x}_{jn} ) \qquad EQ ( 5 )$$

$$and$$

$$BSS ( S ) = {\sum }_{i ∈ S} QS ( {batch}_{i} ) ( 1 + {\prod }_{i \neq j}^{i ∈ S} ( 1 - BS ( {batch}_{i} , {batch}_{j} ) ) ) \qquad EQ ( 6 )$$

Depending on the available computational power, one or more batches may be used. If the number of GPUs and time available is limited, it may be preferable to use only one batch. If more GPUs and time is available, then it may be preferably to use more than one batch.

Batch similarity, batch quality score, and batch selection score may be used as synthetic map image selection metrics. It was found that above metrics may provide improved results over comparative metrics, such as Frechet Inception Distance (FID). The comparative metrics are primarily focusing on evaluating the plausibility and realness of synthetic map images and try to align with human judgment, those comparative metrics do not solely fit to select images for GAN-assisted training. The herein disclosed metrics allow for reliable results for satellite images containing enormous amounts of small objects instead of one or a few center objects. The synthetic dataset does not only contain synthetic map images but also the corresponding ground truth (i.e., the segmentation mask). Besides realness and the appearance of the synthetic map image, the current metrics also allows to evaluate whether the dataset contains useful information of the ground truth for the target main task.

As the quality of the generated synthetic map images varies, the herein disclosed selection metrics may be used to shortlist synthetic images for effective assisted training.

The training 140 the map segmenter 10 with the training dataset TDS1 may include at least 2, for example 3, training phases, wherein: at least one of the training phases is performed with training image data comprising the training pairs (TDP1) and without of additional training data pairs (TDP2); and at least another one of the training phases is performed with the additional training data pairs (TDP2). For example, an initial phase (1st) phase and a fine tuning (3rd) phase may be trained only on the training pairs (TDP1=(22, 32)). In the second phase, part of the time, e.g., 60% of the time, training may be performed on both, the training pairs (TDP1=(22, 32)) and the additional training data pairs (TDP2={(42,32) or (42.32)}) and the remaining time, e.g., 40%, on only the training data pairs (TDP1=(22,32). The synthetic pairs (TDP2) may be switched off in the second phase intermittently.

According to various embodiments, training 140 the map segmenter 10 with the training dataset TDS1 may include a three-phase training. In an example, the three-phases are:
initiation with a map image: e.g., 30 epochs, with learning rate (lr) decay to a pre-defined lr_1;
intermittent training with synthetic data: it is composed of training blocks. Each training block contains a pre-determined number of epochs (e.g., 3 epochs) trained on mixed datasets, followed by another pre-determined number of epochs (e.g. 2 epochs) training on map images (also named as real map images). Learning rate decay and early stopping may be applied on the block level.
fine-tuning on real map images: it continues with the pre-defined learning rate lr_1 to fine-tune on real datasets. Learning rate decay and early stopping may be applied on epoch level.

Various embodiments relate to a computer program product including program instructions, which when executed by one or more processors, cause the one or more processors to perform the computer-implemented training method 100 in accordance with various embodiments.

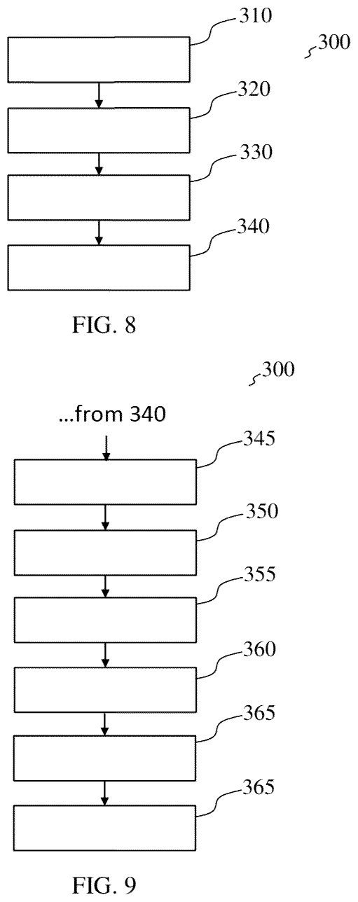

Various embodiments relate to a computer-implemented segmenting method 300 for extracting a road network for use in vehicle routing, which is explained in connection with the flowchart of FIG. 8 for illustration purposes. The segmenting method includes providing a trained segmenter 310 trained by using the training dataset of the training method, thus including the additional training data pairs TDP2 in the training dataset TDS1.

The segmenting method includes providing processing image data 320 including map images acquired by one or more image acquisition devices, e.g., by a satellite. The segmenting method includes segmenting 330, by the trained segmenter, each of the map images thereby determining attributes to different portions of the image. The result of segmentation is to indicate what are the pixels in a given image are occupied by road. For example, the coordinates of image 22 (see FIG. 1) corresponding to road and no-road can be identified by the trained segmenter (e.g., via classification) and the segmentation mask 32 can be created accordingly (whites indicating road, and blacks indicating no road, for illustration purposes). In this case, the classification into road and no-road is an example of determining attributes to different portions of the map image. Since the map image as a satellite image is georeferenced (the location of the images on the earth is known), this road mask may be translated into the world coordinate system. The output of the segmentation may be a binary mask referencing the corresponding satellite image. The segmenting method includes storing 340 the segmented images and the attributes as a road network in a database memory, e.g., the computer memory CM1, for access by vehicle routing services. The road network may be stored a consolidated representation of the segmentation masks. The road network may be stored as a binary representation, e.g., the road network may be transformed into or used to produce a road map, e.g., a vectorized road map. The road map may be stored in a database memory, e.g., the computer memory CM1. The road map may be accessed by vehicle routing services.

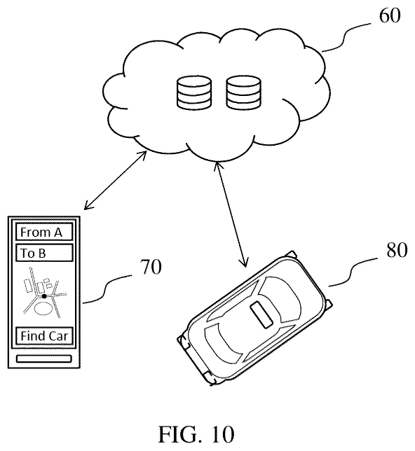

FIG. 9 shows a flowchart of further optional method steps of method 300. FIG. 10 shows a schematic of a user's mobile device 70, and a vehicle 80 which may communicate via a computing system 60, such as a cloud service. The following description makes reference to FIG. 9 and FIG. 10 for illustration purposes. According to various embodiments, the method 300, may further include, by a computing system 60, receiving 345, by a communication interface, a route request from a user's mobile device 70. The method 300, may further include, by a computing system 60, applying 350 a route solver on the route request, the road map, and a fleet of vehicles, thereby providing a viable route for a vehicle 80 of the fleet. The method 300, may further include, by a computing system 60, sending 355 the route data of the viable route to the vehicle 80 (e.g., to a driver's mobile device or to a vehicle integrated navigation system). The method 300, may further include, by a computing system 60, receiving 360 an acknowledgement of service from the vehicle 80 (e.g., from a driver's mobile device or from a vehicle integrated navigation system). The method 300, may further include, by a computing system 60, sending 365 the route data, by the communication interface, to the user's mobile device 70. The method 300, may further include, by a computing system 60, sending 370 the acknowledgement of service, by the communication interface, to the user's mobile device 70. Steps 345 to 365 may also be named as vehicle routing method of a fleet management system.

Alternatively, to the vehicle routing method of a fleet management system above, the method 300 may also be employed for single user routing, e.g., as a navigation system. The method 300 may include, by a computing system 60, receiving 345, by a communication interface, a route request from a vehicle 80. The method 300 may include, by a computing system 60, applying 350 a route solver on the route request and the road map, thereby providing a viable route for the vehicle 80. The method 300 may include, by a computing system 60, sending 355 route data of the viable route to the vehicle 80.

Various embodiments relate to a computer program product including program instructions, which when executed by one or more processors, cause the one or more processors to perform the segmenting method 300 according to various embodiments.

The present disclosure allows for geo-information extraction (e.g. image annotation) of lower resolution images when higher resolution images are limited due to the availability and high cost. Synthetic images are an alternative source to assist the information extraction. Herein, generative adversarial network assisted-training strategy is disclosed which improves model performance the number of available training pairs is limited, for example, when non-annotated high resolution images are available in a larger number than annotated high resolution images, or when high-resolution images are limited. Existing training pairs can be augmented to have different appearances with the same mask and additional training pairs can be generated from real/synthetic road masks at low cost. More importantly, none of the assisted trained models using three-phase training strategy results in a degraded performance compared to the baseline model, which indicates that the present GAN-assisted training method is a useful technique to boost training performance. Experiments of GAN-assisted road segmentation show that an assisted trained model with 1,000 real images achieves Mean intersection over union (mIoU) of 64.44% (improved from mIoU 60.92%), which reaches a similar level of performance as a model that is trained with 4,000 real images (mIoU 64.59%). All of the assisted trained models using a three-phase training strategy improve performance compared to their baseline models.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A computer-implemented training method of training a map segmenter comprising a deep neural network, comprising:
providing a training dataset (TDS1) comprising training image data comprising training pairs (TDP1) of map images of a geographical area (GA1) acquired by one or more image acquisition apparatuses (SAT1) and corresponding segmentation masks, wherein the training image data is stored in a computer memory(CM1);
generating synthetic map images by creating synthetic map images by applying a generative adversarial network (GAN) onto segmentation masks, wherein the segmentation masks comprises the corresponding segmentation masks and additional segmentation masks;
storing the synthetic map images and the corresponding additional segmentation masks as additional training data pairs (TDP2) in the training dataset (TDS1) in the computer memory (CM1); and
training the map segmenter with the training dataset (TDS1).

2. The training method of claim 1, wherein the additional segmentation masks are provided by:
a segmentation mask database and wherein the additional segmentation masks are different from the corresponding segmentation masks corresponding to the map images; or
a segmentation mask generator configured to generate a representation of a road network and transform the representation into the additional segmentation mask.

3. The training method of claim 1, wherein the generative adversarial network (GAN) is trained by training:
a generator model (Gl) with a segmentation mask of the segmentation masks; and
a discriminator model (Dl) configured to discriminate between the image generated by the generator model (Gl) and a map image corresponding to the segmentation mask.

4. The training method of claim 1, wherein creating synthetic map images comprises augmenting the map images by applying the generative adversarial network (GAN) on the corresponding segmentation masks thereby producing augmented images; and the training method comprises storing the augmented images with their corresponding segmentation masks in the training dataset (TDS1) in the computer memory.

5. The training method of claim 1, wherein creating synthetic map images further comprises:
creating a synthetic image of the synthetic map images by applying the generative adversarial network (GAN) onto an additional segmentation mask comprised by the additional segmentation masks.

6. The training method of claim 1, wherein the generative adversarial network (GAN) comprises a conditional-single natural image generative adversarial network (cSinGAN) or a derivate thereof.

7. The training method of claim 1, wherein the generative adversarial network (GAN) comprises a Multi-Categorical-conditional-single natural image generative adversarial network or a derivate thereof.

8. The training method of claim 6, wherein
the cSinGAN comprises two or more generators (CAT=1, CAT=2), each trained for a category of the categories; and
the training method, further comprises, for each generator (CAT=1, CAT=2): inputting a noise tensor into the cSinGAN.

9. The training method of claim 7, wherein
the Multi-Categorical-cSinGAN comprises a multi-scale generator set,
and the training method further comprises
selecting a noise section from a region of a noise space, the noise region corresponding to a given category of the categories, wherein the noise section is randomly selected within the region; and
inputting the noise section as noise tensor into the multi-scale generator set.

10. The training method of claim 1, wherein the training dataset comprises one or more batches, each batch thereof comprising a segmentation mask and a plurality of synthetic map images generated from the segmentation mask; and wherein the training method further comprises calculating a batch quality score (BQS) for each batch.

11. The training method of claim 10, further comprising comparing the batch quality scores of different batches and:
selecting a batch having a highest batch quality score (BQS) among one or more batches: or
calculating a batch similarity (BS), and calculating a batch selection score (BSS) based on the batch similarity (BS) and the batch quality score (BQS), and selecting batches according to the BS;
wherein the batch quality score (BQS) is calculated based on the appearance distance and the content information distance, and
wherein the batch similarity is calculated based on the pairwise structural similarity of two images generated with the same segmentation mask.

12. The training method of claim 11, wherein structural similarity is Multi-Scale Structural Similarity (MS-SSIM).

13. The training method of claim 1, wherein training the map segmenter with the training dataset (TDS1) comprises at least 2, for example 3, training phases, wherein:
at least one of the training phases is performed with training image data comprising the training pairs (TDP1) and without of additional training data pairs (TDP2); and
at least another one of the training phases is performed with the additional training data pairs (TDP2).

14. A computer-implemented segmenting method for extracting a road network for use in vehicle routing, the segmenting method comprising:
providing a trained segmenter trained by using the training dataset of the training method of claim 1;
providing processing image data comprising map images acquired by one or more image acquisition devices;
segmenting, by the trained segmenter, each of the map images thereby determining attributes to different portions of the image;
storing the segmented images and/or the attributes as a road network in a database memory for access by vehicle routing services.

15. The method of claim 14, wherein segmenting further comprises, by the trained segmenter classifying pixels of a, or each, image of the map images into road and no-road.

16. The method of claim 14, further comprising, by a computing system:
receiving, by a communication interface, a route request from a user's mobile device;
applying a route solver on the route request, on a road map produced from the road network, and a fleet of vehicles, thereby providing a viable route for a vehicle of the fleet;
sending the route data of the viable route to the vehicle;
receiving an acknowledgement of service from the vehicle;
sending the route data, by the communication interface, to the user's mobile device;
sending the acknowledgement of service, by the communication interface, to the user's mobile device.

17. The method of claim 14, further comprising, by a computing system:
receiving, by a communication interface, a route request from a vehicle; applying a route solver on the route request and a road map produced from the road network, thereby providing a viable route for the vehicle;
sending route data of the viable route to the vehicle.

18. A computer program product comprising program instructions, which when executed by one or more processors, cause the one or more processors to perform a method of training a map segmenter comprising a deep neural network, the method comprising:
providing a training dataset (TDS1) comprising training image data comprising training pairs (TDP1) of map images of a geographical area (GA1) acquired by one or more image acquisition apparatuses (SAT1) and corresponding segmentation masks, wherein the training image data is stored in a computer memory (CM1);
generating synthetic map images by creating synthetic map images by applying a generative adversarial network (GAN) onto segmentation masks, wherein the segmentation masks comprises the corresponding segmentation masks and additional segmentation masks;
storing the synthetic map images and the corresponding additional segmentation masks as additional training data pairs (TDP2) in the training dataset (TDS1) in the computer memory (CM1); and
training the map segmenter with the training dataset (TDS1).
